(19) United States
(12) Patent Application Publication
(10) Pub. No.: US 2011/0083617 A1
(43) Pub. Date: Apr. 14, 2011

(54) DEVICE FOR RESTRAINING ANIMALS TO FIXTURES

(76) Inventors: Eric Townsend, San Diego, CA (US); Janis Paglilla, San Diego, CA (US)

(21) Appl. No.: 12/901,362

(22) Filed: Oct. 8, 2010

Related U.S. Application Data
(60) Provisional application No. 61/278,747, filed on Oct. 9, 2009.

(51) Int. Cl. A01K 29/00

(52) U.S. Cl. 119/797; 119/795

(57) ABSTRACT

A restraining device for animals may comprise a housing including a leash rope assembly, a handle including a first end and a second end coupled to the housing, wherein at least one end of the handle is configured to be detachable from the housing, and an aperture generally positioned between the handle and the housing, wherein the aperture is configured to contain at least one fixture via detaching the at least one end of the handle from the housing such that the restraining device may be removably coupled to the at least one fixture.

### CROSS-REFERENCE TO RELATED APPLICATIONS

This is a United States Non-Provisional Application claiming the benefit of priority to U.S. Provisional Patent Application Ser. No. 61/278,747, entitled “ANIMAL LEASH ASSEMBLY SYSTEM AND RELATED METHODS,” filed on Oct. 9, 2009, which is hereby incorporated by reference herein.

### BACKGROUND OF THE INVENTION

1. Field of Invention

The present disclosure relates generally to a restraining device for animals, and more particularly, to a device for restraining animals to fixtures.

2. Description of the Related Art

In order to conform to the pet leash laws provided in many places, pet owners may be required to restrain their pets by either holding onto a leash attached to their pets or coupling their pets to fixtures in the environment so as to prevent their pet from moving about on their own. Current methods for coupling pets to fixtures are rudimentary and are often undesirable in use because of the significant amount of time that must be expended. Furthermore, pet owners may express a lack of confidence in how securely their pet is coupled to the fixture.

Moreover, many pet owners are active individuals who enjoy engaging in physical activities such as walking, running, rollerblading, and the like. For such individuals, they tend to avoid means for coupling their pets to fixtures which may involve them carrying additional hardware and/or tools in addition to the animal leash device to which to which their pets are coupled to. Many pet owners may become discouraged from engaging in their fun, physical activity if they become disenchanted with having to constantly carry such hardware and tools.

### SUMMARY

Broadly speaking, the invention relates to a restraining device for animals, and more particularly, to a restraining device for removably coupling animals to fixtures.

In one embodiment, the restraining device for animals may comprise: a housing including a leash rope assembly; a handle including a first end and a second end coupled to the housing, wherein at least one end of the handle is configured to be detachable from the housing; and an aperture generally positioned between the handle and the housing, wherein the aperture is configured to contain at least one fixture via detaching the at least one end of the handle from the housing such that the restraining device may be removably coupled to the at least one fixture.

In another embodiment, the restraining device may comprise: an elongated member; a leash coupling element, generally positioned at a first end of the elongated member; and one or more attachment members, generally positioned at a second end of the elongated member, wherein the one or more attachment members are configured to be detachably coupled to a handle of an animal leash device, and where an aperture having an exposed configuration is formed in an area between the restraining device and the animal leash device, wherein the aperture is configured to contain at least one fixture such that the animal leash device may be removably coupled to the at least one fixture.

The above and other features will be presented in more detail in the following detailed description and the associated figures. Other aspects and advantages will become apparent from the following detailed description, taken in conjunction with the accompanying drawings.

### BRIEF DESCRIPTION OF DRAWINGS

The accompanying drawings, which are incorporated into and constitute a part of this specification, illustrate one or more example embodiments and, together with the description of example embodiments, serve to explain the principles and implementations.

In the drawings:

FIG. 1A illustrates a perspective view of one embodiment of a restraining device for animals having an exposed aperture configuration.

FIG. 1B illustrates a perspective view of one embodiment of a restraining device for animals having a sealed aperture configuration.

FIG. 2A illustrate a side view of the one embodiment of the restraining device having the at least one fixture positioned within the aperture having a sealed configuration.

FIG. 2B illustrates a side view of the one embodiment of the restraining device having the at least one fixture contained within the aperture having a sealed configuration.

FIG. 3 illustrates an exemplary flow diagram of a method for using the restraining device for animals.

FIG. 4 illustrates a side view of an alternative embodiment of a restraining device for animals.

FIG. 5A illustrates a side view of the alternative embodiment of a restraining device for animals where the aperture is in the exposed configuration.

FIG. 5B illustrates a side view of the alternative embodiment of a restraining device where the aperture is in the sealed configuration.

FIG. 6 illustrate perspective views of one embodiment of the first end and the locking element of the restraining device

FIG. 7 illustrates an exemplary flow diagram of a method for using the restraining device for animals.

FIG. 8 illustrates one example of placement of the restraining device for animals to the at least one fixture.

FIG. 9 illustrates a perspective view of yet another embodiment of a restraining device for animals.

FIG. 10 illustrates a side view of the restraining device for animals placement to a animal leash device.

FIG. 11A illustrates a perspective view of yet another embodiment of the restraining device for animals in the exposed aperture configuration.

FIG. 11B illustrates a perspective view of yet another embodiment of the restraining device for animals in the sealed aperture configuration.

FIG. 12 illustrates an exemplary flow diagram of a method for using the restraining device for animals.

### DESCRIPTION

Embodiments are described herein in the context of a Device for Restraining Animals to Fixtures. The following detailed description is illustrative only and is not intended to be in any way limiting. Other embodiments will readily suggest themselves to such skilled persons having the benefit of this disclosure. Reference will now be made in detail to implementations as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

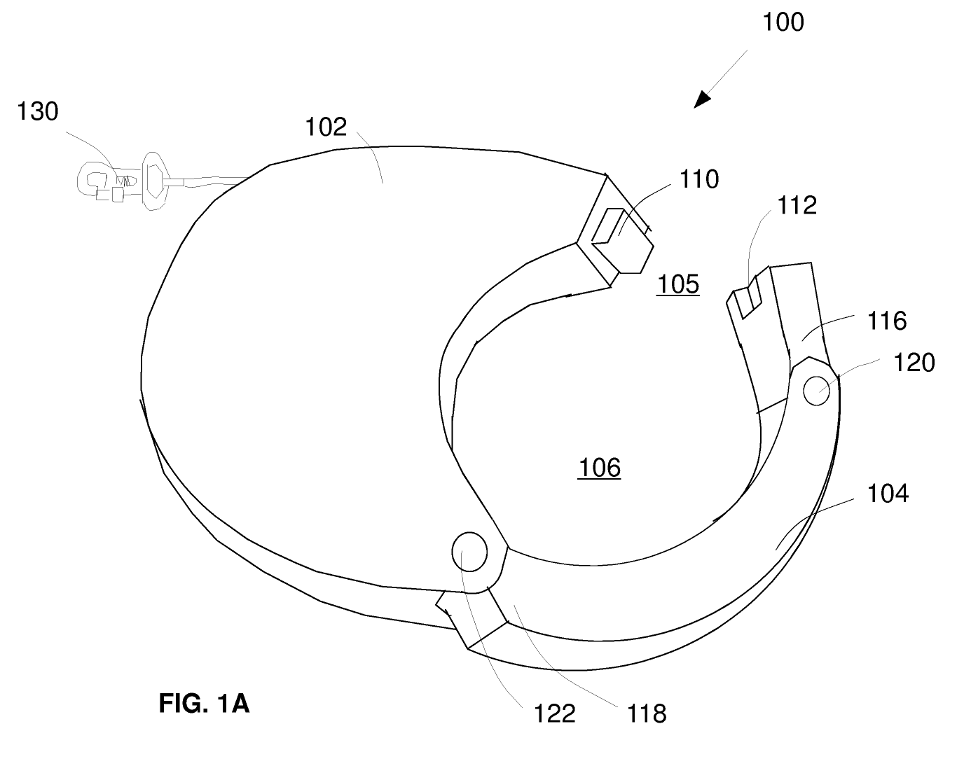

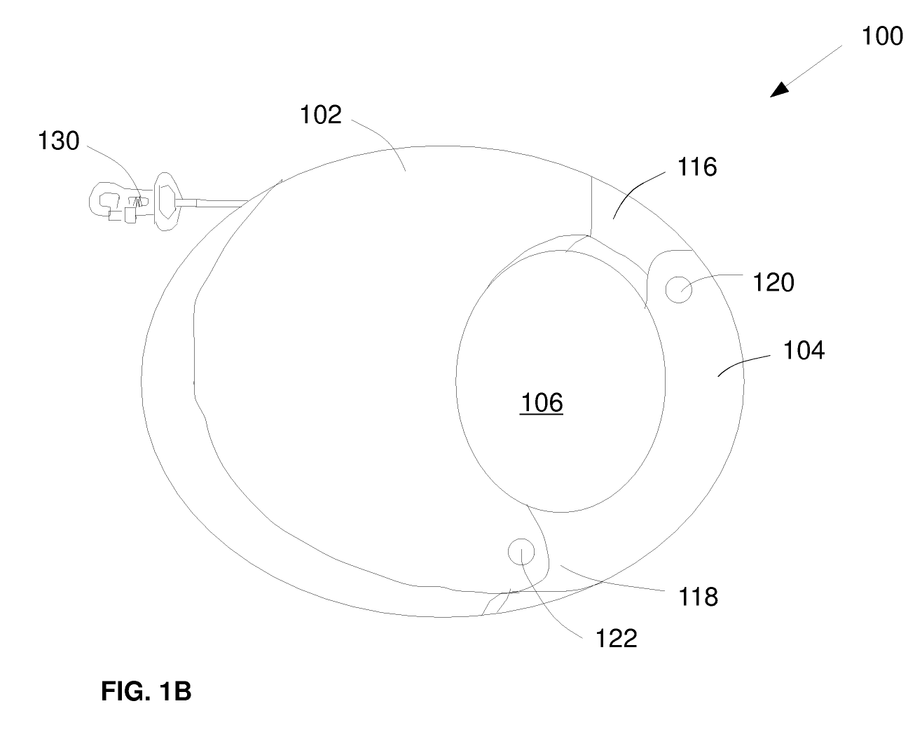

FIG. 1A illustrates a perspective view of one embodiment of a restraining device for animals where the aperture may include an exposed configuration and FIG. 1B illustrates a perspective view of the restraining device for animals where the aperture may include a sealed configuration. The restraining device 100 may include a housing 102, a handle 104, and an aperture 106.

The housing 102 may be configured to include a leash rope assembly 130. The housing 102 may be comprised of any material having sufficient rigidity, strength, impact resistance, and generally toughness qualities sufficient to restrain the movement of animals including by way of example only, thermoplastic. The leash rope assembly 130 may include a collar coupling member, which may be coupled to a receiving member found on the collar of an animal so as to generally restrain the animal's movement. The leash rope assembly 130 may be one of a retractable or a non-retractable means.

Referring now to FIG. 1A, according to one embodiment, the handle 104 may include a first end 116 and a second end 118. The handle 104 may be configured so as to be contoured to fit the shape of the user's fingers. The first end 116 of the handle 104 may be configured to include a receiving slot 112. The receiving slot 112 may be configured to be coupled to the locking element 110 of the housing 102. By way of example, the locking element 110 may be configured to be inserted within the receiving slot 112 so as to provide a more secure coupling effect between the handle 104 and the housing 102. The first end 116 of the handle 104 may be configured to rotate about a first pivot 120, the first pivot 120 located along a portion between the first end 116 and the second end 118 of the handle 104. By changing the rotation of the first end 116 of the handle 104 via the first pivot 120, the receiving slot 112 of the first end 116 of the handle 104 may be configured to change in a similar rotation so as to enhance the coupling of the locking element 110 to the first end 116. In another embodiment, the portion of the handle 104 may not include a first pivot 120, such that the first end 116 of the handle 104 may not be configured to rotate about the first pivot 120.

According to one embodiment, the second end 118 of the handle 104 may be configured to be coupled to the housing 102 via a second pivot 122. When the first end 116 of the handle 104 is decoupled from the housing 102, the handle 104 may be configured to swing about the housing 102 via the second pivot 122. Swinging the handle 104 about the second pivot 122 may adjust the size of the aperture 106 and/or adjust the size of an entrance 105 to the aperture 106.

The aperture 106 may be generally positioned between the first end 116 and the second end 118 of the handle 104 and the housing 102. The aperture 106 may be configured to be toggled between one of an exposed configuration or one of a sealed configuration (as illustrated in FIGS. 1A and 1B, respectively). Although the aperture 106 is illustrated as having a generally oval shape, the aperture 106 may be of any variety of shape configurations such as rectangular, circular, or other shapes as is known in the art. That is, the aperture 106 may be provided in a variety of different shapes having a purely structural purpose, a purely aesthetic purpose, or both a structural purpose and an aesthetic purpose.

The aperture 106 may be configured to contain at least one fixture. The at least one fixture may be any type of fixture which is sufficient to restrain the mobility of animals in an environment. Furthermore, the at least one fixture may be any variety of object, which may or may not be attached to the environment. For example, the at least one fixture may include a tree, fence, post, the trailer hitch of a vehicle, a belt worn by a person, or other fixture as is known in the art.

The exposed configuration of the aperture 106 may be when the first end 116 of the handle 104 is decoupled from the locking element 110 of the housing 102 such that the aperture 106 is of sufficient size to permit the at least one fixture to be positioned within the aperture 106. The aperture 106 may include the entrance 105, from which the at least one fixture is to be introduced through in order to be positioned within the aperture 106. According to another embodiment, the exposed configuration of the aperture 106 may be when the second end 118 of the handle 104 is decoupled from the housing 102. Furthermore, when the second end 118 of the handle 104 is coupled to the housing 102, then the aperture 106 may be in the sealed configuration.

Referring now to FIG. 1 B, the sealed configuration of the aperture 106 may be when the first end 116 of the handle 104 is coupled to the locking element (e.g., reference 110, FIG. 1 A) of the housing 102 such that the at least one fixture can no longer be positioned within the aperture 106 nor can the at least one fixture presently contained within the aperture 106 be removed from the aperture 106. In the sealed configuration, the at least one fixture may be contained within the aperture 106 such that the restraining device 100 may be removably coupled to the at least one fixture. By removably coupling the restraining device 100 to the at least one fixture, the animal coupled to the restraining device 100 via the leash rope assembly 130 may thereby also be removably coupled to the at least one fixture.

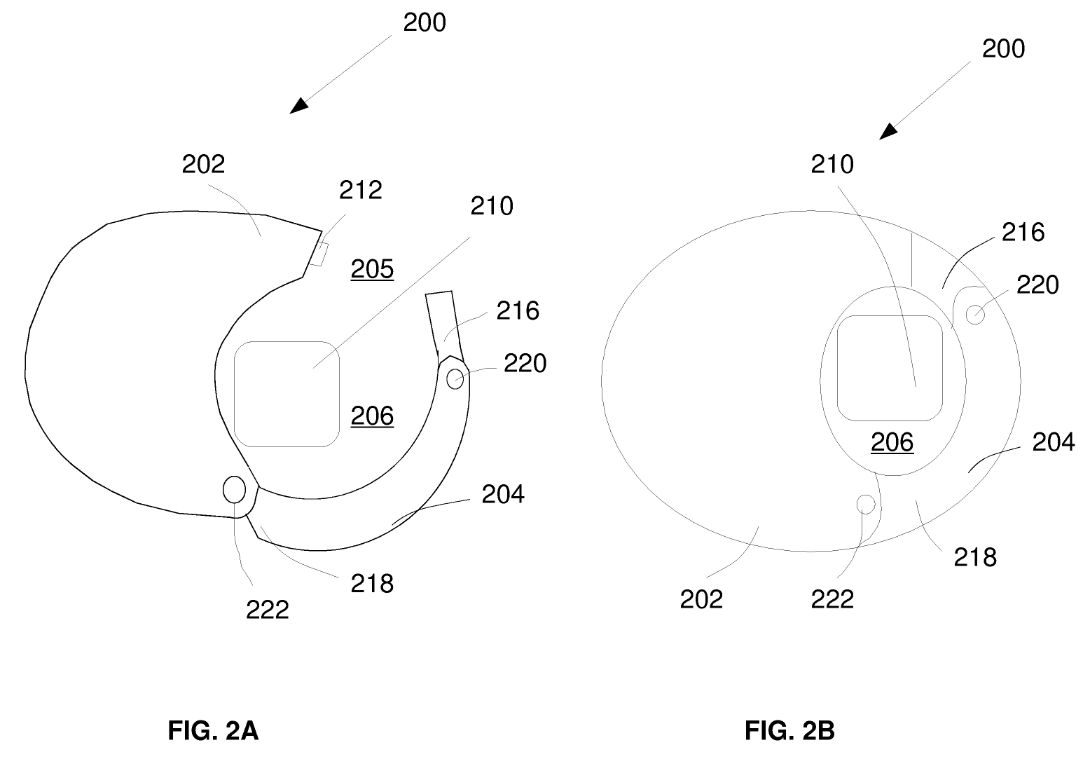

FIGS. 2A-B illustrate a side view of the restraining device for animals where the at least one fixture is positioned within the aperture. According to one embodiment, the first end 216 of the handle 204 may be configured to be detachably coupled to the housing 202 via the locking element 212. By decoupling the first end 216 of the handle 204 from the locking element 212 of the housing 202, the first end 216 of the handle 204 may be configured to swing about the first pivot 220. When the first end 216 of the handle 204 is decoupled from the locking element 212 of the housing 202, then the second end 218 of the handle 204 may be configured to rotate about the second pivot 222.

By way of example, one fixture 210 is shown positioned within the aperture 206. However, more than one fixture 210 may be positioned within the aperture 206. In use, the size of the aperture 206 may be adjusted by rotating the handle 204 about the second pivot 222. This may also allow for the entrance 205 of the aperture 206 to receive fixtures having various sizes and shapes because, according to one example, the entrance 205 may be narrower than the aperture 206 itself. Additionally, the size of the entrance 205 of the aperture 206 may be adjusted by rotating the first end 216 about the first pivot 220.

The aperture 206 may be configured to be toggled between the sealed configuration and the exposed configuration. Referring now to FIG. 2A, the at least one fixture 210 may be positioned within the aperture 206 having an exposed configuration. The first end 216 may be decoupled from the locking element 212 of the housing 202, such that the handle 204 may be configured to be swing about the second pivot 222 of the housing 202. In the exposed configuration, the aperture 206 of the restraining device 200 may be configured to include at least one fixture 210 to be positioned within the aperture 206.

Referring now to FIG. 2B, the at least one fixture 210 may be contained within the aperture 206 having the sealed configuration. The first end 216 of the handle may be coupled to the housing 202, such that the handle 204 may be immobilized and incapable of swinging about the second pivot 222. In use, the aperture 206 in the sealed configuration may be configured to contain the at least one fixture within the aperture 206 such that the presently contained at least one fixture cannot be removed, nor can additional fixtures be positioned within the aperture 206.

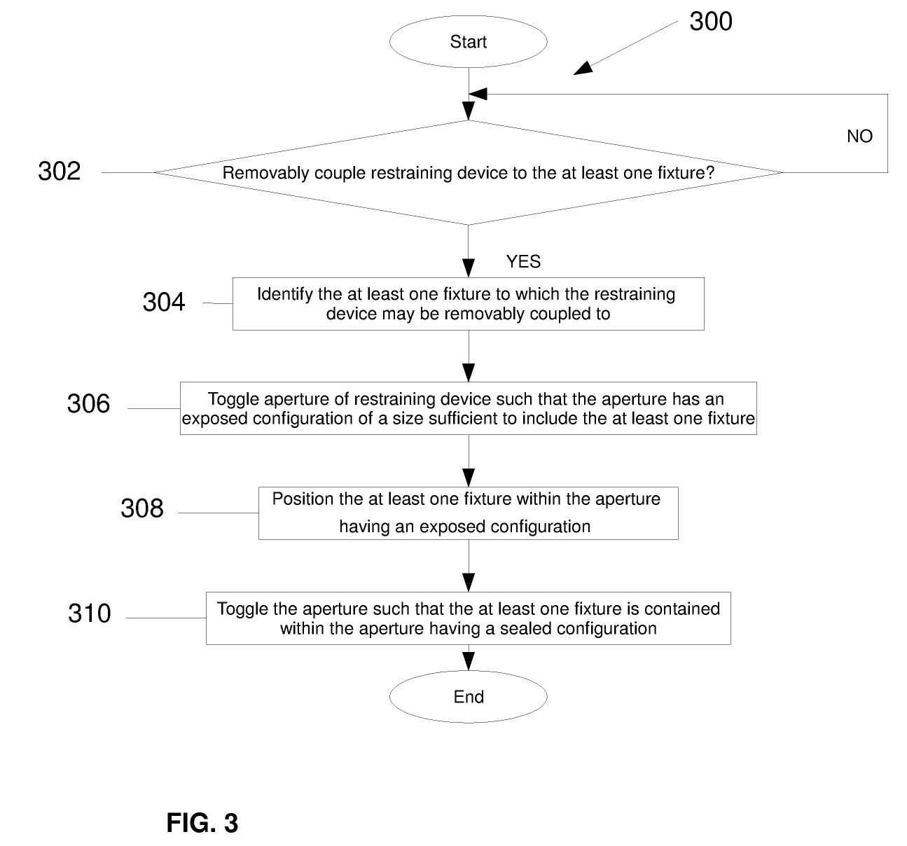

FIG. 3 illustrates an exemplary flow diagram of a method for using the restraining device for animals. The method 300 may provide for the decision as to whether to removably couple the restraining device to the at least one fixture at 302. If it is determined that the at least one fixture is not to be removably coupled to the restraining device, then no further action is to be taken. Alternatively, if it is determined that the restraining device is to be removably coupled to the at least one fixture, then an identification may be made of the at least one fixture to which the restraining device may be removably coupled at 304. Thereafter, the aperture of the restraining device may be toggled such that the aperture may have the exposed configuration where the size of the aperture is sufficient to include the at least one fixture at 306; if the aperture was not previously in an exposed configuration.

Subsequently at 308, the at least one fixture may be positioned through the entrance of the aperture, where the aperture has an exposed configuration. In use, both the size of the entrance to the aperture and the size of the aperture may be adjusted such as to accommodate fixtures of a variety of sizes. Once the at least one fixture is positioned within the aperture, the aperture of the restraining device may be toggled such that the aperture may have the sealed configuration at 310. In the sealed configuration, the at least one fixture may be contained within the aperture. Once the at least one fixture is contained within the aperture having the sealed configuration, then the restraining device has been coupled to the at least one fixture. By removably coupling the restraining device to the at least one fixture, the animal coupled to the restraining device via the leash rope assembly may thereby also be removably coupled to the at least one fixture.

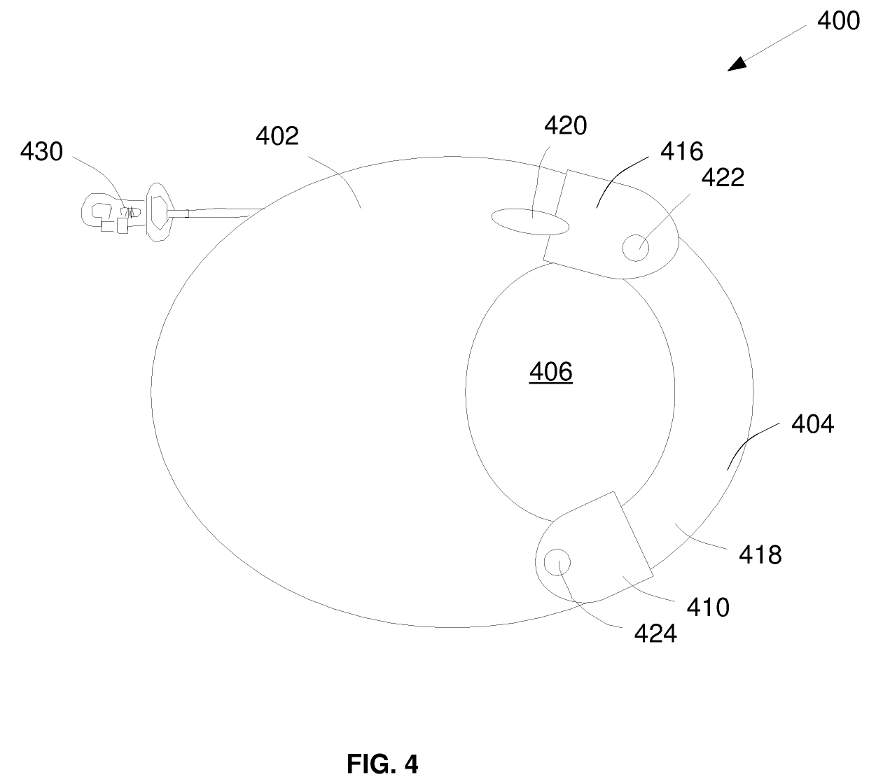

FIG. 4 illustrates a side view of an alternative embodiment of a restraining device for animals. The restraining device 400 may include a housing 402, a handle 404, and an aperture 406. The housing 402 may be configured to include a leash rope assembly. According to one embodiment, the handle 404 may include a first end 416 and a second end 418. The handle 404 may be configured so as to be contoured to fit the shape of the user's fingers. When the first end 416 of the handle 404 is decoupled from the locking element (not illustrated) of the housing 402, then the first end 416 of the handle 404 may be configured to rotate about a first pivot 422 in a plurality of directions. The first pivot 422 may be configured to be positioned along a portion of the handle 404 between the first end 416 and the second end 418. By changing the rotation of the first end 416 of the handle 404 via the first pivot 422, a receiving slot (not illustrated) of the first end 416 may be configured to be more securely coupled to a locking element (not illustrated) of the housing 402. Furthermore, the first end 416 may also be configured to be coupled to a locking switch 420, of which the locking switch may be positioned on the distal end of the housing 402. By way of example, the locking switch 420 may be of a sliding type, configured to more securely couple the first end 416 to the housing 402 when the aperture 406 is in the sealed configuration.

According to one embodiment, a portion of the housing 402 may include a retention member 410. The second end of the handle 418 may be configured to be detachably coupled to the retention member 410. Furthermore, the retention member 410 may be configured to rotate about a second pivot 424. The second pivot 424 may be configured to generally enhance the coupling of the second end of the handle 418 to a receiving slot (not illustrated) of the retention member 410.

In another embodiment, the portion of the handle 404 may not include a first pivot 422, such that the first end 416 of the handle 404 may not be configured to rotate about the first pivot 422. Additionally, the portion of the housing 402 may not include a second pivot 424, such that the retention member 410 may not be configured to rotate about a portion of the housing 402.

The aperture 406 may be generally positioned between the first end 416 and the second end 418 of the handle 404 and the housing 402. The aperture 406 may be configured to be toggled between a sealed configuration and an exposed configuration. The aperture 406 may be configured to contain at least one fixture. Furthermore, the size of the aperture 406 may be adjusted so as to accommodate a variety of fixtures of different sizes and shapes. The at least one fixture may any variety of object, which may or may not be attached to the environment. For example, the at least one fixture may include a tree, fence, post, the trailer hitch of a vehicle, a belt worn by a person, or other fixture as is known in the art. Although the aperture 406 is illustrated as having a generally oval shape, the aperture 406 may be of any variety of shape configurations such as rectangular, square, circular, or other shapes as is known in the art. That is, the aperture 406 provided in a variety of different shapes may have a purely structural purpose, a purely aesthetic purpose, or both a structural purpose and an aesthetic purpose.

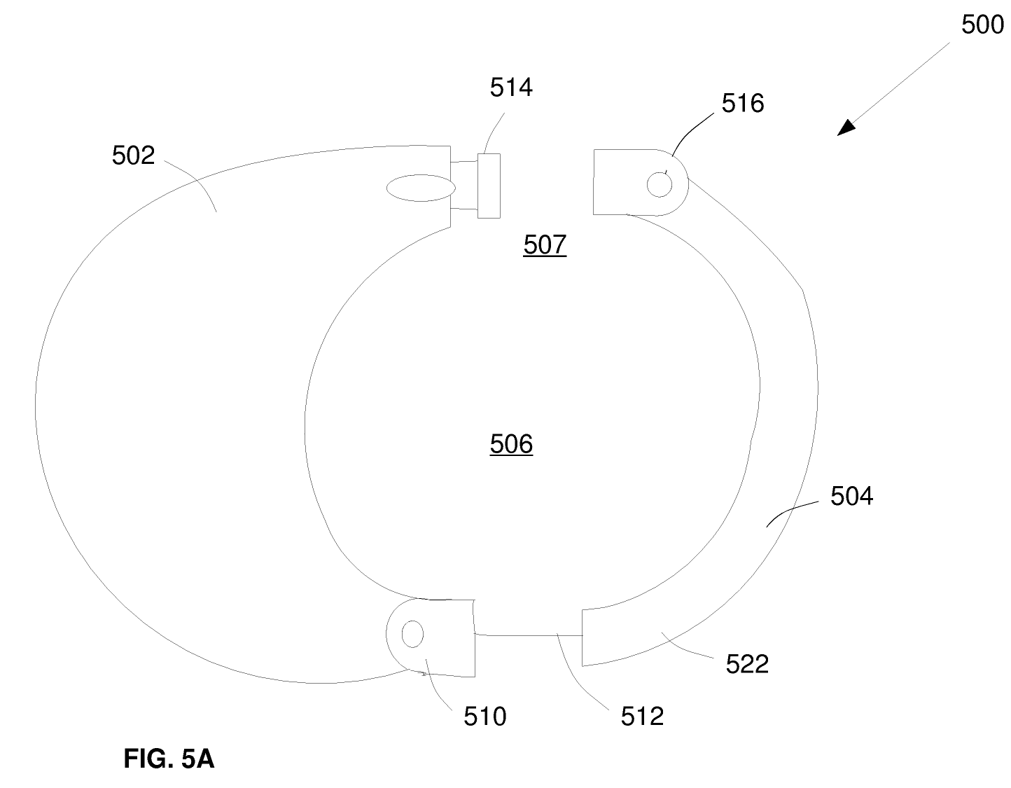

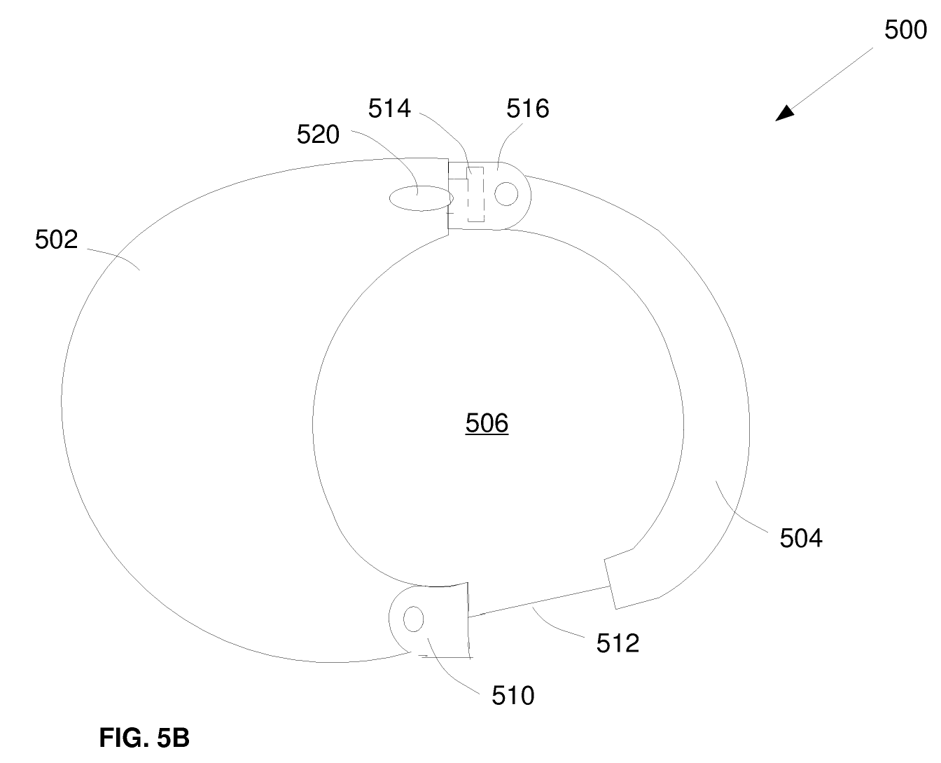

FIGS. 5A-B illustrate side views of the another embodiment of the restraining device for animals having an exposed configuration and a sealed configuration, respectively. The housing 502 of the restraining device 500 may include a locking element 514. The locking element 514 may generally protrude some distance from the distal end of a portion of the housing 502. The locking element 514 may be configured to be coupled to a receiving slot (not illustrated) of the first end 516 of the handle 504.

According to one embodiment, the aperture 506 may be configured to be toggled between the sealed configuration and the exposed configuration. Referring now to FIG. 5A, the aperture 506 is illustrated in the exposed configuration. The first end 516 of the handle 504 may be decoupled from the locking element 514 of the housing 502, such that the handle 504 may be configured to be pulled away from the housing 502. In the exposed configuration, the aperture 506 of the restraining device 500 may be configured to receive at least one fixture to be positioned within the aperture 506. The second end of the handle 518 may be configured to be decoupled from a receiving slot (not illustrated) of the retention member 510. However, the second end of the handle 518 may still be coupled to the retention member 510 via a retractable rope 512. The aperture 506 may include the entrance 507, from which the at least one fixture is to be introduced through in order to be positioned within the aperture 506.

The retractable rope 512 may be configured to be operated via a spring-loaded spool (not illustrated) that may be included within the housing 502. The length of the retractable rope 512 may be configured to be one of extended, retracted, or unchanged in length. When the length of the retractable rope 512 is extended, the size of the aperture 506 may be enlarged. Alternatively, when the retractable rope 512 is retracted, the size of the aperture 506 may be reduced. As such, the retractable rope 512 may be configured to permit for adjustments to be made to both an entrance 507 to the aperture 506 and the size of the aperture 506, while the aperture 506 is in the exposed configuration. This may allow for the entrance 507 of the aperture 506 to receive fixtures having varying sizes and shapes because, according to one example, the entrance 507 may be narrower than the aperture 506 itself. Additionally, the size of the entrance 507 of the aperture 506 may be adjusted according to the changed distance between the first end 516 and the locking element 514.

Referring now to FIG. 5B, the aperture 506 is illustrated in the sealed configuration. In the sealed configuration, the first end 516 may be configured to be coupled to the locking element 514 of the housing 502. In the sealed configuration, the aperture 506 may be configured to preclude the at least one fixture to be positioned within the aperture 506 as well as preclude the removal of the at least one fixture presently contained within the aperture 506. Once the at least one fixture is contained within the aperture 506 having the sealed configuration, then the restraining device 500 has been coupled to the at least one fixture. By removably coupling the restraining device to the at least one fixture, the animal coupled to the restraining device 500 via the leash rope assembly may thereby also be removably coupled to the at least one fixture.

Furthermore, the first end 516 may also be configured to be coupled to a locking switch 520, where the locking switch may be positioned on the distal end of the housing 502. By way of example, the locking switch 520 may be of a sliding type, configured to more securely couple the first end 516 of the handle 504 to the locking element 514 of the housing 502 when the aperture 506 is in the sealed configuration.

According to another embodiment, in the sealed configuration, the second end 518 of the handle 504 may not be coupled to the receiving slot (not illustrated) of the retention member 510. Instead the retractable rope 512 may be configured to be one of extended, retracted, or of unchanged in length. As such, the retractable rope 512 may be configured to permit for adjustments to the size of the aperture 506, while the aperture 506 is in the sealed configuration.

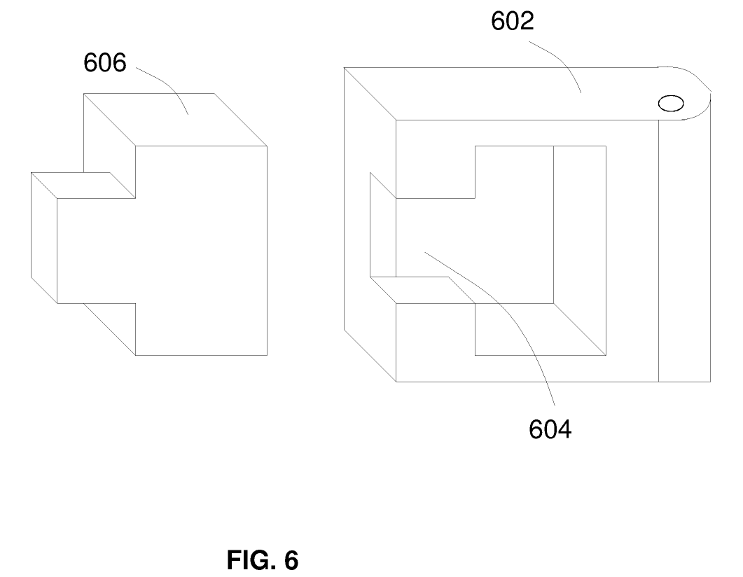

FIG. 6 illustrate perspective views of one embodiment of the first end of the handle and the locking element of the restraining device (e.g., reference 516 and 514 in FIG. 5A, respectively). The first end 602 of the handle may include a receiving slot 604. The receiving slot 604 may be configured to be removably coupled to the locking element 606. The receiving slot 604 by way of example shows a generally T-shaped slot. However, the shape of the receiving slot is not limited to a T-shape, and may be comprised of any variety of shapes as is known in the art.

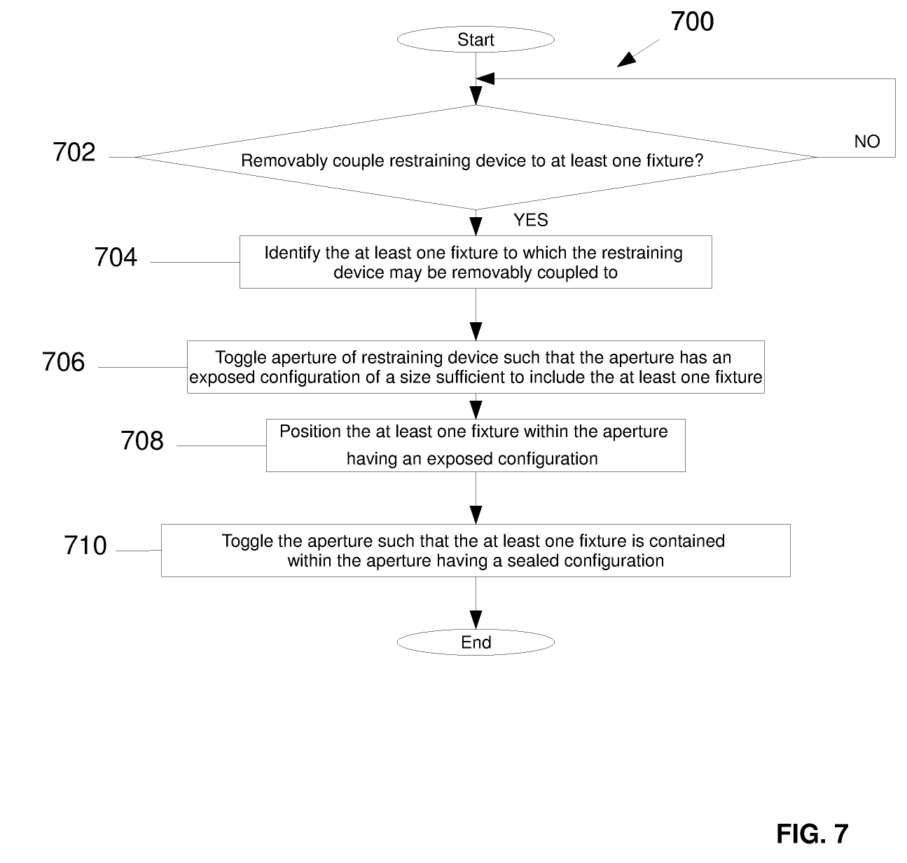

FIG. 7 illustrates an exemplary flow diagram of a method for using the restraining device for animals. The method 700 may provide for the decision as to whether to removably couple the restraining device to the at least one fixture at 702. If it is determined that the at least one fixture is not to be removably coupled to the restraining device, then no further action is to be taken. Alternatively, if it is determined that the restraining device is to be removably coupled to the at least one fixture, then an identification may be made of the at least one fixture to which the restraining device may be removably coupled at 704. Thereafter, the aperture of the restraining device may be toggled such that the aperture may have the exposed configuration where the size of the aperture is sufficient to include the at least one fixture at 706; if the aperture was not previously in an exposed configuration.

Subsequently at 708, the at least one fixture may be positioned within the aperture where the aperture has an exposed configuration. In use, the entrance of the aperture and the size of the aperture may be adjusted such as to accommodate fixtures of a variety of sizes and shapes while the aperture is in the exposed configuration. Once the at least one fixture is positioned within the aperture, the aperture of the restraining device may be toggled such that the aperture may have the sealed configuration at 710. The at least one fixture may be contained within the aperture having the sealed configuration. Once the at least one fixture is contained within the aperture having the sealed configuration, then the restraining device has been coupled to the at least one fixture. By removably coupling the restraining device to the at least one fixture, the animal coupled to the restraining device via the leash rope assembly may thereby also be removably coupled to the at least one fixture.

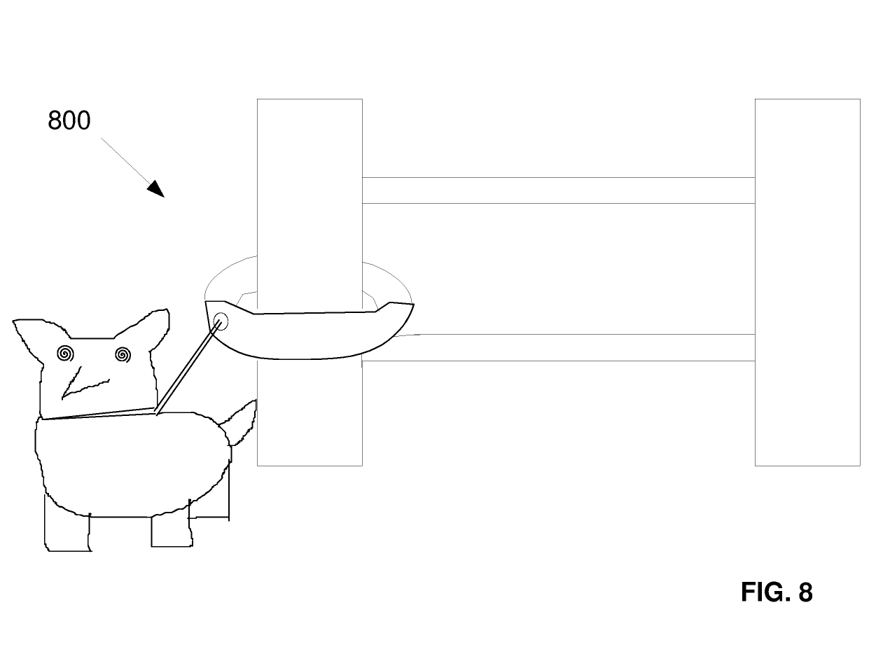

FIG. 8 illustrates one example of placement of the restraining device for animals to the at least one fixture. By way of example, the restraining device 800 may be removably coupled to a fence post.

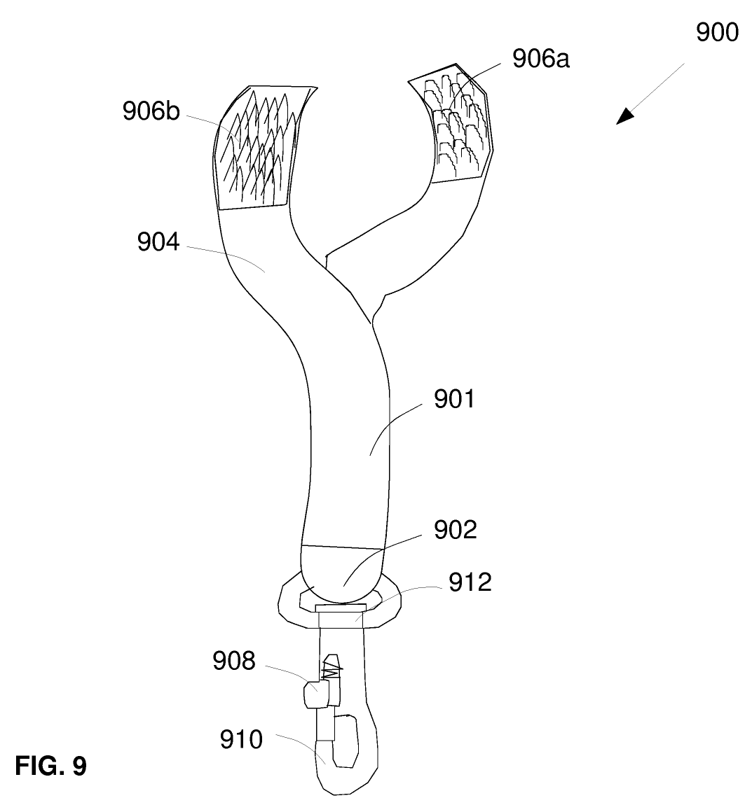

FIG. 9 illustrates a perspective view of yet another embodiment of a restraining device for animals. The restraining device 900 may include an elongated member 901, one or more attachment members 906a-b, and a leash coupling element 910. The elongated member 901 may include a first end 902 and a second end 904. Furthermore, the elongated member 901 may be configured to be adjustable in length such that the restraining device 900 may be adaptable for use a wide variety of environments and fixtures. The elongated member 901 may be comprised of a generally rip-stop material. Such rip-stop material may include ballistic nylon; however, other types of materials may be used including flexible steel or other material as is known in the art. The elongated member 901 may be comprised of a pliable material, such that the elongated member 901 may be configured to be folded against the surface(s) of fixture(s).

Positioned generally on the first end 902 of the elongated member 901 may include a leash coupling element 910. The leash coupling element 910 may be configured to be removably coupled to a portion of a leash rope of an animal leash device (not illustrated). The leash coupling element 910 may be configured to be toggled between one of an open configuration or a closed configuration by pressing down on a spring-loaded button 908. The leash coupling element 910 may be configured to rotate in a plurality of directions about a first end 902 of the elongated member 901 via a pivot 912.

Positioned generally on the second end 904 of the elongated member 901 may include the one or more attachment members 906a-b. As illustrated, the one or more attachment members 906a-b may be configured to include a hook and loop fastener to which the one or more attachment members 906a-b may be removably coupled to a handle of the animal leash device such that the restraining device 900 may be removably coupled to the handle of the animal leash device.

According to one embodiment, there may be only one attachment member 906a. The one attachment member 906a may include two sides: one side may include a hook fastener and the other side may include a loop fastener such that the attachment member 906a can be configured to be wrapped around the handle of the animal leash device so that the side including the hook fastener may be removably coupled to the side including the loop fastener.

According to another embodiment, there may be a first and second member 906a and 906b, where one side of the first attachment member 906a may include a hook fastener and one side of the second attachment member 906b may include a loop fastener. Although the attachment member 906a-b is illustrated as having a hook and loop fastener other means of attaching the restraining device 900 to the handle of the animal leash device may utilized such as a clasp, button, buckle, ladder lock, tri-glide, or other attachment mechanism as is known in the art. Furthermore, the attachment members 906a-b may also be comprised of generally rip-stop material.

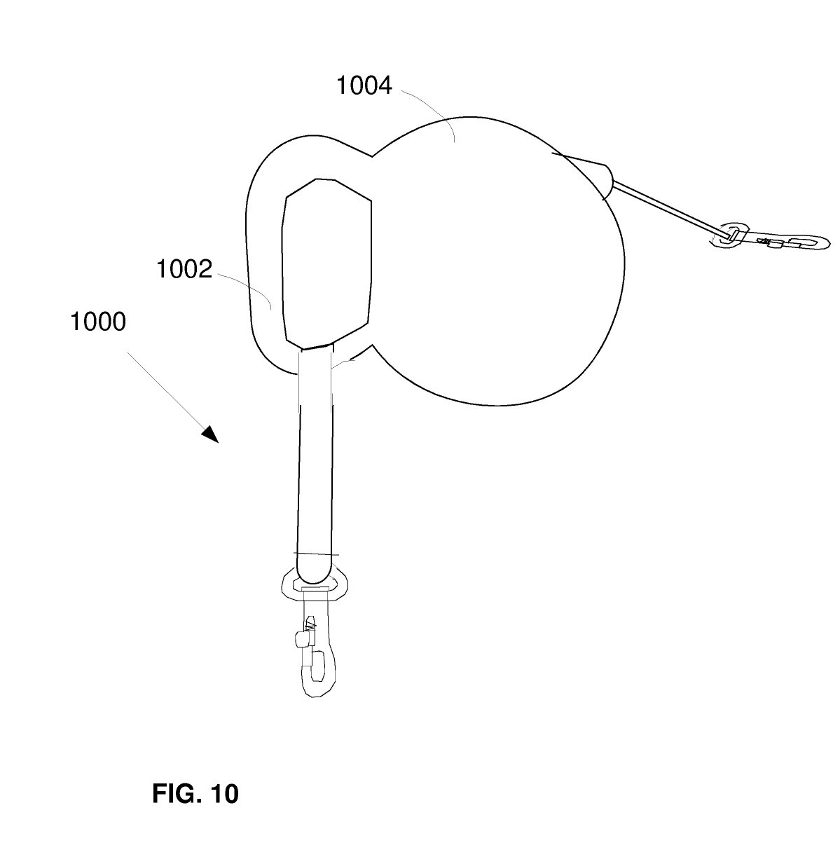

FIG. 10 illustrates a side view of the yet another embodiment for the restraining device for animals placement to the animal leash device. By way of example, the restraining device 1000 may be coupled to the handle 1002 of the animal leash device 1004 via the one or more attachment members (e.g., reference 906a-b, FIG. 9).

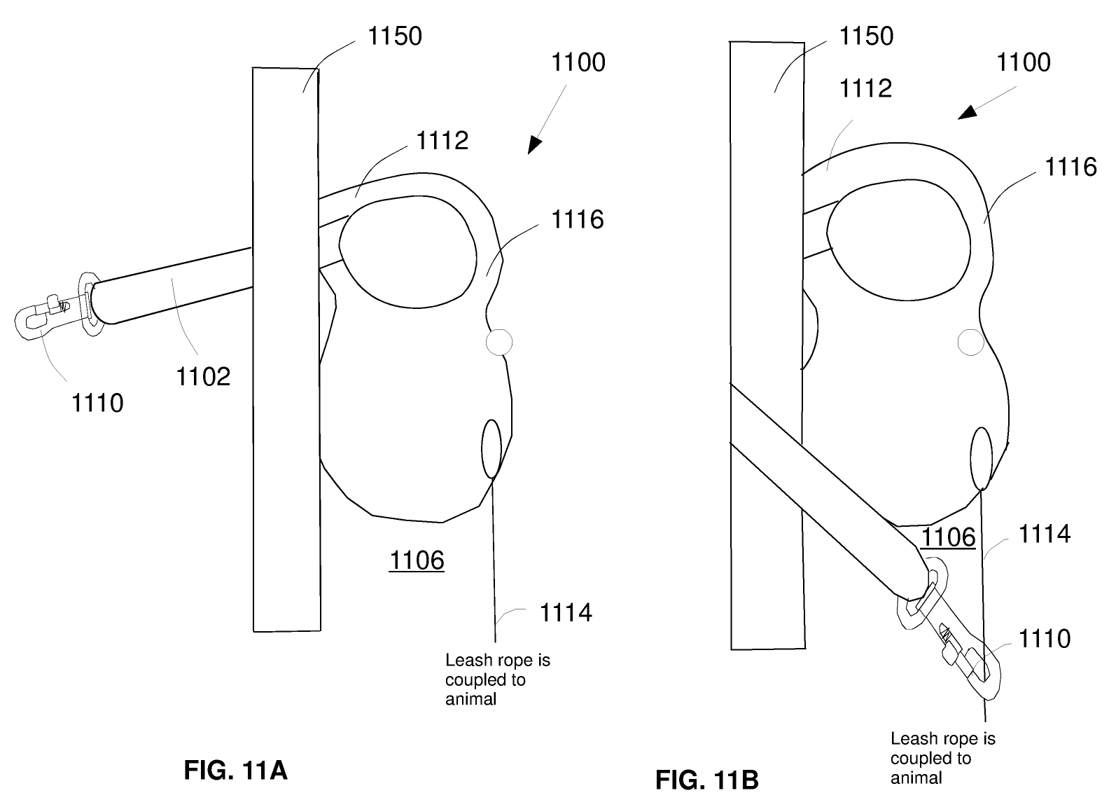

FIGS. 11A and 11B illustrate perspective views of yet another embodiment of the restraining device for animals in the exposed aperture configuration and the sealed aperture configuration, respectively. According to one embodiment, the aperture 1106 may be configured to be toggled between the exposed configuration and the sealed configuration. Referring now to FIG. 11A, the aperture 1106 is illustrated in the exposed configuration. The aperture 1106 having an exposed configuration may be formed in an area between the restraining device 1100 and the animal lash device 1116, such that the at least one fixture 1150 may be configured to be positioned within the aperture 1106. The one or more attachment members (reference 906a-b, FIG. 9) may be removably coupled to the handle 1112 of the animal leash device 1116. The animal leash device 1116 may be configured to be positioned near the at least one fixture 1150. The elongated member 1102 may be folded about the at least one fixture 1150 such that the leash coupling element 1110 may clear the width of the at least one fixture 1150.

Referring now to FIG. 11B illustrates the aperture 1106 in a sealed configuration. In the sealed configuration, the aperture 1106 may be configured to contain at least one fixture 1150, such that the animal leash device may be removably coupled to the at least one fixture 1150. The leash coupling element 1110 may be coupled to the portion of the leash rope 1114 of the animal leash device, such that the aperture in the area between the restraining device and the animal leash device is in the sealed configuration. In the sealed configuration, the aperture 1106 may be configured to preclude the at least one fixture 1150 to be positioned within the aperture 1106 as well as preclude the removal of the at least one fixture 1150 presently positioned within the aperture 1106. In the sealed configuration, the animal leash device 1116 may be removably coupled to the at least one fixture 1150. By removably coupling the animal leash device 1116 to the at least one fixture 1150, the animal coupled to the animal leash device 1116 via the leash rope 1114 may thereby also be removably coupled to the at least one fixture 1150.

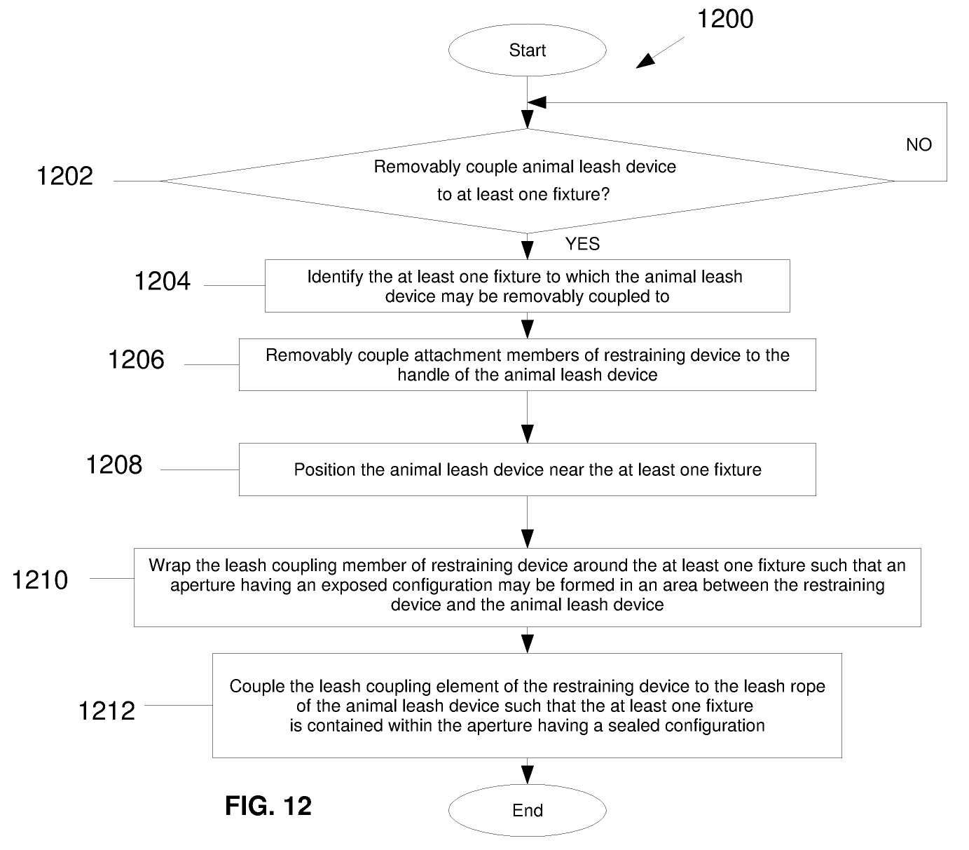

FIG. 12 illustrates an exemplary flow diagram of a method for using the restraining device for animals. The method 1200 may provide for the decision as to whether to removably couple the animal leash device to the at least one fixture at 1202. If it is determined that the animal leash device is not to be removably coupled to the at least one fixture, then no further action is to be taken. Alternatively, if it is determined that the animal leash device is to be removably coupled to the at least one fixture, then identification is made of the at least one fixture to which the animal leash device may be removably coupled to at 1204. Thereafter, the one or more attachment members of the restraining device may be removably coupled to the handle of the animal leash device at 1206. Subsequently, the animal leash device may be positioned near the at least one fixture at 1208. Thereafter, the leash coupling element of the restraining device may be wrapped around the at least one fixture such that an aperture having an exposed configuration may be formed in an area between the restraining device and the animal leash device at 1210. The at least one fixture may be positioned within the aperture having the exposed configuration.

Once the at least one fixture is positioned within the aperture, the leash coupling element of the restraining device may be removably coupled to the leash rope of the animal leash device such that the at least one fixture is contained within the aperture having the sealed configuration at 1212. Once the at least one fixture is contained within the aperture having the sealed configuration, then the restraining device may be removably coupled to the at least one fixture. By removably coupling the animal leash device to the at least one fixture, the animal coupled to the animal leash device via the leash rope may thereby also be removably coupled to the at least one fixture.

While embodiments and applications of this invention have been shown and described, it would be apparent to those skilled in the art having the benefit of this disclosure that many more modifications than mentioned above are possible without departing from the inventive concepts herein. For example, the closure member may be a drawstring or any other similar closure device.

What is claimed is:

1. A restraining device for animals, comprising:
a housing including a leash rope assembly;
a handle including a first end and a second end coupled to the housing, wherein at least one end of the handle is configured to be detachable from the housing; and
an aperture generally positioned between the handle and the housing, wherein the aperture is configured to contain at least one fixture via detaching the at least one end of the handle from the housing such that the restraining device may be removably coupled to the at least one fixture.

2. The restraining device for animals of claim 1, wherein the aperture is configured to be in one of an exposed configuration or a sealed configuration.

3. The restraining device for animals of claim 1, wherein the housing may include a retention member.

4. The restraining device for animals of claim 1, wherein the first end of the handle may be configured to pivot about a portion of the handle.

5. The restraining device for animals of claim 3, wherein the second end of the handle may be coupled to the retention member via a retractable rope.

6. The restraining device for animals of claim 5, wherein the retractable rope may be configured to increase the size of the aperture.

7. The restraining device for animals of claim 5, wherein the retractable rope may be configured to decrease the size of the aperture.

8. The restraining device for animals of claim 2, wherein while the aperture is in the sealed configuration, the size of the aperture may be adjusted.

9. A restraining device for animals, comprising:
an elongated member;
a leash coupling element, generally positioned at a first end of the elongated member; and
one or more attachment members, generally positioned at a second end of the elongated member, wherein the one or more attachment members are configured to be detachably coupled to a handle of an animal leash device, and where an aperture having an exposed configuration is formed in an area between the restraining device and the animal leash device, wherein the aperture is configured to contain at least one fixture such that the animal leash device may be removably coupled to the at least one fixture.

10. The restraining device for animals of claim 9, wherein the elongated member is adjustable in length.

11. The restraining device for animals of claim 9, wherein the one or more attachment members are configured to operate by a hook-and-loop fastener.

12. The restraining device for animals of claim 9, wherein the elongated member is comprised of a rip-stop material.

13. A method for forming a restraining device for animals, said method comprising:
obtaining a housing, the housing including a leash rope assembly;
obtaining a handle having a first end and a second end, wherein at least one end of the handle is configured to be detachable from the housing; and
coupling the handle to the housing such that an aperture is generally formed between the handle and the housing, wherein the aperture is configured to contain at least one fixture by detaching the at least one end of the handle from the housing such that the restraining device may be removably coupled to the at least one fixture.

14. The restraining device for animals of claim 13, wherein the aperture is configured to be in one of an exposed configuration or a sealed configuration.

15. The restraining device for animals of claim 13, wherein the housing includes a retention member.

16. The restraining device for animals of claim 13, wherein the first end of the handle may be configured to pivot about a portion of the handle.

17. The restraining device for animals of claim 15, wherein the second end of the handle may be coupled to the retention member via a retractable rope.
